(19) United States
(12) Patent Application Publication
(10) Pub. No.: US 2023/0347825 A1
(43) Pub. Date: Nov. 2, 2023

(54) ELECTROCHROMIC REARVIEW MIRROR ASSEMBLY WITH LARGE VIEWABLE REFLECTIVE REGION

(71) Applicant: AIMCORE TECHNOLOGY CO., LTD., Hsinchu County (TW)

(72) Inventors: Ming-Chun CHIANG, Hsinchu County (TW); I-Chiao LIN, Hsinchu County (TW)

(21) Appl. No.: 17/733,841

(22) Filed: Apr. 29, 2022

(51) Int. Cl. B60R 1/08; B60R 16/02; B60R 1/12; G02F 1/153

(52) U.S. Cl. CPC B60R 1/088; B60R 16/02; B60R 1/12; G02F 1/1533; G02F 2001/1536

(57) ABSTRACT

Provided is an electrochromic rearview mirror assembly with a large viewable reflective region, comprising a first portion, a second portion, and an electrochromic medium. The first portion comprises a first substrate and a light-transmitting conductive layer disposed on the first substrate. The second portion comprises a second substrate and a transflective conductive layer disposed on the second substrate. The electrochromic medium is arranged between the first portion and the second portion. The area of the light-transmitting conductive layer of the first portion is greater than that of the electrochromic medium, such that a first conductive region is exposed at a rear side of the light-transmitting conductive layer. The second substrate of the second portion has a through-hole parallel to a viewing direction, such that a second conductive region is exposed at a rear side of the transflective conductive layer.

### FIELD OF THE INVENTION

The present invention relates to an electrochromic rearview mirror assembly, and relates in particular to an electrochromic rearview mirror assembly of an automotive vehicle with large viewable reflective region.

### BACKGROUND OF THE INVENTION

Recently, electrochromic technology has begun to be applied to vehicle rearview mirrors, and can be used in combination with an ambient light sensor to monitor ambient light intensity and to output signals to control an electrochromic element of a vehicle rearview mirror, so as to change the light absorption properties of the electrochromic element and the reflection ratio of the vehicle rearview mirror to light. Accordingly, the eyes of a driver can be prevented from being affected by high-intensity reflected light.

The prior art can be found in US Publication No. 20210245661, U.S. patent Ser. No. 10/343,608, U.S. patent Ser. No. 10/179,546, U.S. Pat. No. 9,694,751, U.S. patent Ser. No. 10/976,588, U.S. patent Ser. No. 10/823,882, US Patent No. 10739591 and the like.

In the prior art, in order to arrange an electrochromic element, it is necessary to introduce an electrical connection structure (such as U.S. patent Ser. No. 10/703,282) or an electrical insulating structure (such as U.S. patent Ser. No. 10/399,498) into the vehicle rearview mirror. Such structure is usually provided on an edge of the electrochromic element, and thus requires a hiding layer for shielding. As a result, the viewable reflective region of the rearview mirror is reduced (or, in other words, the ratio of the viewable reflective region to the shielded region is reduced), and the overall appearance is negatively affected.

### BRIEF DESCRIPTION OF THE DRAWINGS

FIG. 1A is a schematic cross-sectional view according to a first embodiment of the present invention.

FIG. 1B is a partially enlarged schematic view of FIG. 1A.

FIG. 2A to FIG. 2B are exploded schematic diagrams according to an embodiment of the present invention.

FIG. 3 is a schematic cross-sectional view according to a second embodiment of the present invention.

### SUMMARY OF THE INVENTION

A main object of the invention is to solve the problem that the viewable reflective region of the existing electrochromic rearview mirror is narrow.

The invention provides an electrochromic rearview mirror assembly with large viewable reflective region, which comprises a first portion, a second portion, and an electrochromic medium. The first portion comprises a first substrate and a light-transmitting conductive layer, the first substrate comprises a first outer side surface and a first inner side surface, and the light-transmitting conductive layer is disposed on the first inner side surface of the first substrate. The second portion comprises a second substrate and a transflective conductive layer, the second substrate is disposed opposite to the first substrate and comprises a second outer side surface and a second inner side surface, and the transflective conductive layer is disposed on the second inner side surface of the second substrate, wherein a viewing direction from the first portion towards the second portion is defined. The electrochromic medium is disposed between the light-transmitting conductive layer of the first portion and the transflective conductive layer of the second portion. An area of the light-transmitting conductive layer of the first portion is greater than that of the electrochromic medium such that a first conductive region is exposed at a rear side of the light-transmitting conductive layer, and the second substrate of the second portion comprises a through-hole parallel to the viewing direction such that a second conductive region is exposed at a rear side of the transflective conductive layer.

The invention further provides an electrochromic rearview mirror assembly with large viewable reflective region, which comprises a first portion, a second portion, a sealing member, an electrochromic medium, a first electrical connection portion, and a second electrical connection portion. The first portion comprises a first substrate, a hiding layer, and a light-transmitting conductive layer, the first substrate comprises a first outer side surface and a first inner side surface, the hiding layer is disposed on a peripheral region of the first inner side surface of the first substrate, the light-transmitting conductive layer is disposed on a middle region of the first inner side surface of the first substrate and on the hiding layer, and the light-transmitting conductive layer is located on the middle region being a viewable reflective region. The second portion comprises a second substrate and a transflective conductive layer, the second substrate is disposed opposite to the first substrate and comprises a second outer side surface and a second inner side surface, and the transflective conductive layer is disposed on the second inner side surface of the second substrate, wherein a viewing direction from the first portion towards the second portion is defined, and the second substrate of the second portion has a through-hole parallel to the viewing direction such that a second conductive region is exposed at a rear side of the transflective conductive layer, the through-hole being close to a first lateral end of the mirror assembly. The sealing member is disposed between an edge of the first portion and an edge of the second portion, and the first portion, the second portion, and the sealing member define a chamber, wherein an area of the light-transmitting conductive layer of the first portion is greater than that of the sealing member and the second portion such that a first conductive region is exposed at a rear side of the light-transmitting conductive layer, and a ring-shaped space is preserved outside the second portion, the first conductive region being close to a second lateral end of the mirror assembly. The electrochromic medium is disposed in the chamber. The first electrical connection portion is electrically connected to the first conductive region and accommodated in the ring-shaped space. The second electrical connection portion comprises a conductive column filled in the through-hole so as to electrically connect to the transflective conductive layer, and a conductive plate is disposed on the second outer side surface of the second substrate.

The hiding layer is at least higher than and shields the sealing member and the through-hole when viewed in the viewing direction, and the through-hole is arranged to be as close to the first lateral end of the mirror assembly as possible so that a width of the hiding layer is minimized.

### DETAILED DESCRIPTION OF THE PREFERRED EMBODIMENTS

The terminology used herein in the description of the various embodiments is for the purpose of describing particular examples only and is not intended to be limiting. As used herein, the singular forms “a,” “an,” and “the” include the plural forms as well, unless the context clearly indicates otherwise, or intentionally defines the number of elements.

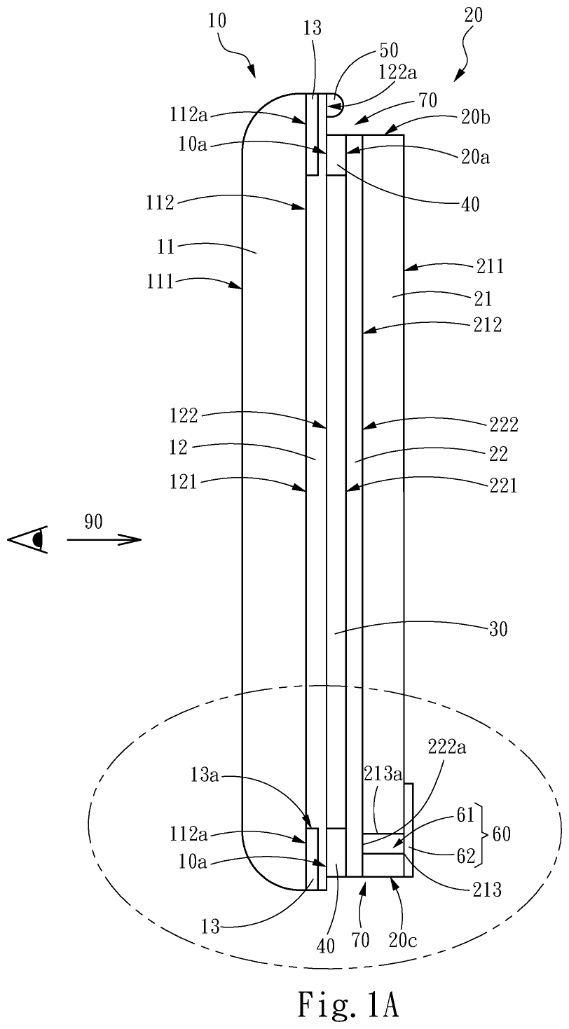

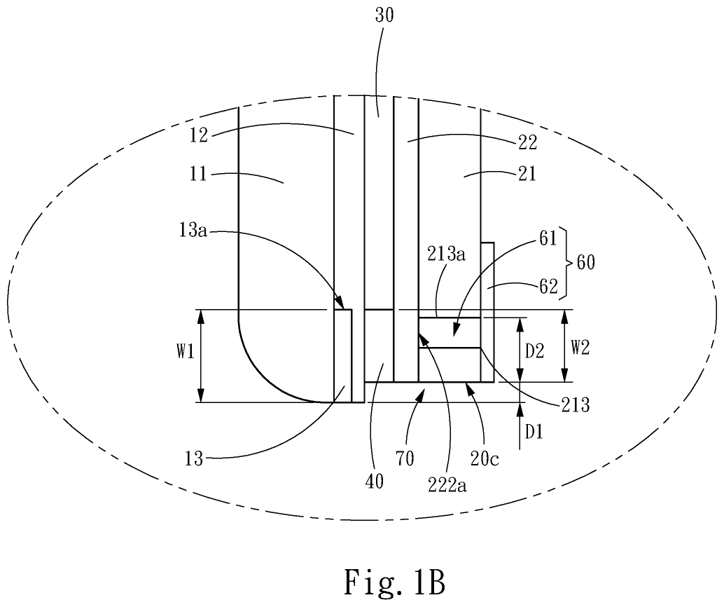

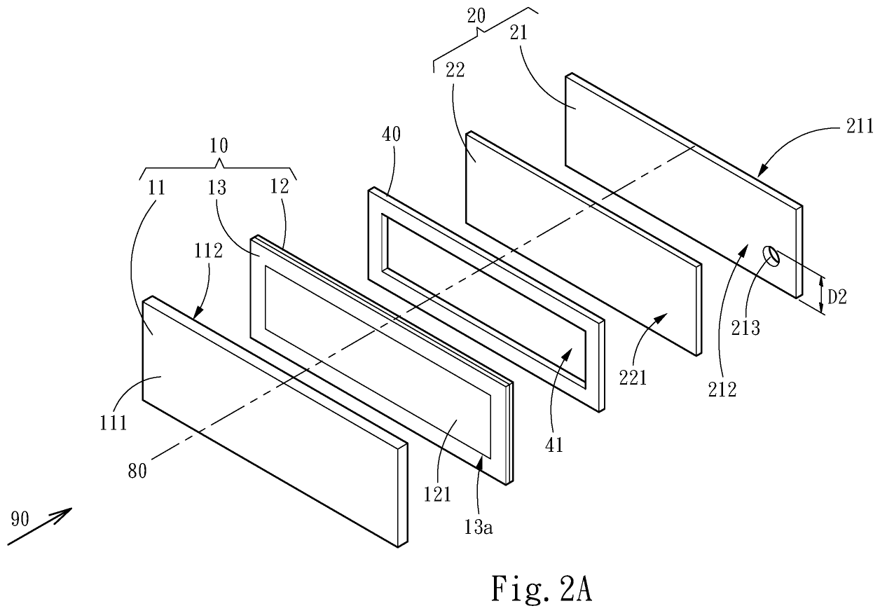

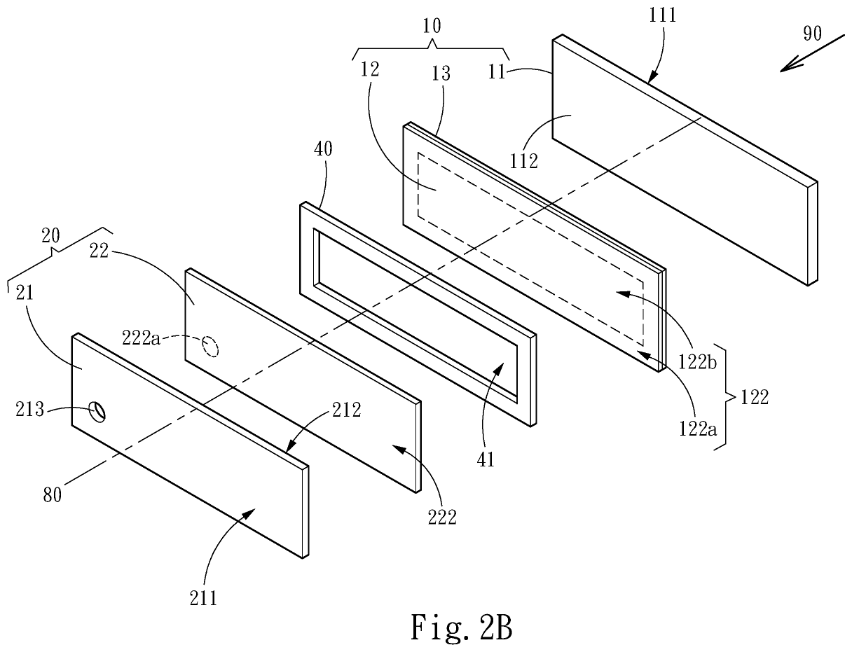

Disclosed in the present invention is an electrochromic rearview mirror assembly with a large viewable reflective region. Referring to FIG. 1A to FIG. 1B and FIG. 2A to FIG. 2B, in one embodiment, the electrochromic rearview mirror assembly comprises a first portion 10, a second portion 20, an electrochromic medium 30, a sealing member 40, a first electrical connection portion 50 and a second electrical connection portion 60. Viewed from the side, there is an area difference between the first portion 10 and the second portion 20, so that a space 70 is preserved outside the second portion 20. The space 70 is provided for arrangement of a frame therein, and the space 70 above the second portion 20 further has the first electrical connection portion 50 arranged therein. Respective layers of the first portion 10 and the second portion 20 are arranged in a stacking direction 80.

The first portion 10 comprises a first substrate 11, a light-transmitting conductive layer 12 and a hiding layer 13. The first substrate 11 comprises a first outer side surface 111 and a first inner side surface 112, and the light-transmitting conductive layer 12 and the hiding layer 13 are disposed on the first inner side surface 112 of the first substrate 11. The first portion 10 can be regarded as a front part, i.e., the first portion 10 faces a user, and a viewing direction 90 of the user is from the first outer side surface 111 towards the first inner side surface 112. The second portion 20 can be regarded as a rear part. Viewed from the viewing direction 90, the hiding layer 13 is in the shape of a ring. During manufacture, the hiding layer 13 is first formed on a peripheral region 112a of the first inner side surface 112, and then the light-transmitting conductive layer 12 is formed on a middle region of the first inner side surface 112 and the hiding layer 13.

The second portion 20 comprises a second substrate 21 and a transflective conductive layer 22. The second substrate 21 is disposed opposite to the first substrate 11. The second substrate 21 comprises a second outer side surface 211 and a second inner side surface 212. The transflective conductive layer 22 is disposed on the second inner side surface 212 of the second substrate 21.

The first substrate 11 is made of an insulating material that is transparent to visible light and has sufficient strength under operating conditions of automobiles, such as glass, polymer or plastic, wherein the glass can be borosilicate glass, soda lime glass, float glass, or the like. The requirements for the second substrate 21 are similar to those for the first substrate 11, except that the second substrate 21 does not need to be transparent. The second substrate 21 can be glass, ceramic, polymer or plastic.

The sealing member 40 is disposed between an outer annular region 10a on a back surface of the first portion 10 and an outer annular region 20a on a front surface of the second portion 20. The light-transmitting conductive layer 12, the transflective conductive layer 22, and the sealing member 40 define a chamber 41 for accommodating the electrochromic medium 30. Two sides of the electrochromic medium 30 are in contact with the light-transmitting conductive layer 12 and the transflective conductive layer 22, respectively.

The sealing member 40 is used to prevent the electrochromic medium 30 from leaking out. In one example, the sealing member 40 may be an epoxy resin. The light-transmitting conductive layer 12 and the transflective conductive layer 22 are used as electrodes, respectively. The light-transmitting conductive layer 12 is made of a material with high light transmittance and good conductivity, such as fluorine-doped tin oxides, doped zinc oxides, indium zinc oxides (Zn₃In₂O₆), indium tin oxides (ITO), ITO/metal/ITO (IMI), etc. The transflective conductive layer 22 has a multi-layer structure, and is both transflective and conductive.

The area of the light-transmitting conductive layer 12 is greater than that of the electrochromic medium 30. The light-transmitting conductive layer 12 comprises a front surface 121 and a back surface 122. The back surface 122 includes a first conductive region 122a and a first electrical contact region 122b. A profile of the first electrical contact region 122b corresponds to the sealing member 40 (or the chamber 41), and is surrounded by the first conductive region 122a. In other words, the first electrical contact region 122b is located at a central portion of the back surface 122, and the first conductive region 122a is located outside the central portion of the back surface 122. The first conductive region 122a is exposed at the back surface 122 of the light-transmitting conductive layer 12 (in comparison, the first electrical contact region 122b of the light-transmitting conductive layer 12 contacts and is covered by the electrochromic medium 30). In the present embodiment, the area of the light-transmitting conductive layer 12 is greater than that of the sealing member 40, and the first conductive region 122a is provided for the light-transmitting conductive layer 12 to connect to an external electrical connection line. It can be understood that in the present embodiment, a back surface 122 of the first portion 10 is the back surface 122 of the light-transmitting conductive layer 12, and the outer annular region 10a and the first conductive region 122a are both located on the back surface 122. However, the outer annular region 10a is different from the first conductive region 122a. The outer annular region 10a is the location in which the sealing member 40 is provided, and the first conductive region 122a is exposed outside and is the locaiton in which the first electrical connection portion 50 is provided.

In the second portion 20, the second substrate 21 and the transflective conductive layer 22 have substantially the same area and contour. The second substrate 21 comprises a through-hole 213 parallel to the stacking direction 80. The transflective conductive layer 22 comprises a front surface 221 and a back surface 222. The through-hole 213 allows a second conductive region 222a to be exposed at the back surface 222 of the transflective conductive layer 22. The second conductive region 222a is provided for the transflective conductive layer 22 to connect to an external electrical connection line. In the present embodiment, the through-hole 213 is perpendicular to a surface of the second substrate 21.

The first electrical connection portion 50 is a conductive block, which may be made of a conductive adhesive. The first electrical connection portion 50 is formed on the first conductive region 122a of the light-transmitting conductive layer 12 at a position away from the second portion 20. The first electrical connection portion 50 does not approach or contact the second portion 20, so as to prevent the external electrical connection line connected thereon from contacting the second portion 20. The second electrical connection portion 60 comprises a conductive column 61 and a conductive plate 62. The conductive column 61 can also be made of a conductive adhesive and is filled in the through-hole 213. One end of the conductive column 61 contacts the transflective conductive layer 22, and the other end of the conductive column 61 is located on the second outer side surface 211 of the second substrate 21. The conductive plate 62 is disposed on the second outer side surface 211 of the second substrate 21 and is in contact with the conductive column 61. In this way, each of the first electrical connection portion 50 and the second electrical connection portion 60 can be connected to a power source via a first electrical connection line and a second electrical connection line, such that an electric field is applied to the electrochromic medium 30 via the the light-transmitting conductive layer 12 and the transflective conductive layer 22, thereby adjusting the color and/or transmittance of the electrochromic medium 30.

The purpose of disposing the hiding layer 13 is to shield elements in the viewing direction 90, such as the sealing member 40, the first electrical connection portion 50 and the second electrical connection portion 60, so that viewing of the user is not affected. In addition, in the present embodiment, in order to ensure that the second portion 20 and other components (such as the first electrical connection line connected to the first electrical connection portion 50) do not cause short circuits due to accidental contact, further insulation can be implemented around the second portion 20, and the insulation is ensured by wrapping the perimeter of the second portion 20 (when viewed in the viewing direction 90). In an example of the present invention, a top end 20b and a bottom end 20c of the second portion 20 are preferably provided with an insulating layer, respectively.

In the present invention, the viewable reflective region of the electrochromic rearview mirror assembly is dependent on the region of the light-transmitting conductive layer 12 not surrounded by the hiding layer 13 (such as the front surface 121 of the light-transmitting conductive layer 12 in FIG. 2A). In other words, for lens assembles having the same area, the smaller the area of the hiding layer 13, the greater the viewable reflective region. That is to say, owing to the through-hole 213 on the second substrate 21 for to be filled with the conductive adhesive, a peripheral space (a bottom space below the second portion 20) for accommodating the electrical connection of the transflective conductive layer 22 could be omitted. In the end, the area ratio of the viewable reflective region to the hiding layer 13 is reduced.

The area of the hiding layer 13 needs to be large enough to shield the through-hole 213 and the sealing member 40 in the viewing direction 90. FIG. 1B shows that the hiding layer 13 below the electrochromic rearview mirror assembly comprises a width W1. The width W1 affects the area of the hiding layer 13. The size of the width W1 depends on: a. a segment difference D1 between the first portion 10 and the second portion 20; b. a width W2 of the sealing member 40; and c. the dimension and location of the through-hole 213.

In the example of FIG. 1B, an outer edge 213a of the through-hole 213 is separated from the bottom end 20c of the second portion 20 by a distance D2, and the through-hole 213 is located below an upper edge 13a of the hiding layer 13. In other words, the width W2 is greater than the distance D2. Accordingly, the width W1 of the hiding layer 13 is equivalent to the segment difference D1 plus the width W2.

In terms of structural design, the width W2 must be large enough to allow the sealing member 40 to be assembled and prevent the electrochromic medium 30 from leaking out, and is usually a fixed parameter. Therefore, the segment difference D1 is a primary variable affecting the width W1. In the structure disclosed in the present invention, since the through-hole 213 is provided in the second substrate 21 as an electrical connection path for one of the electrodes, the electrical connection path does not need to be provided in the space 70 below. For the bottom side of the electrochromic rearview mirror assembly, the segment difference D1 between the first portion 10 and the second portion 20 can be reduced as much as possible.

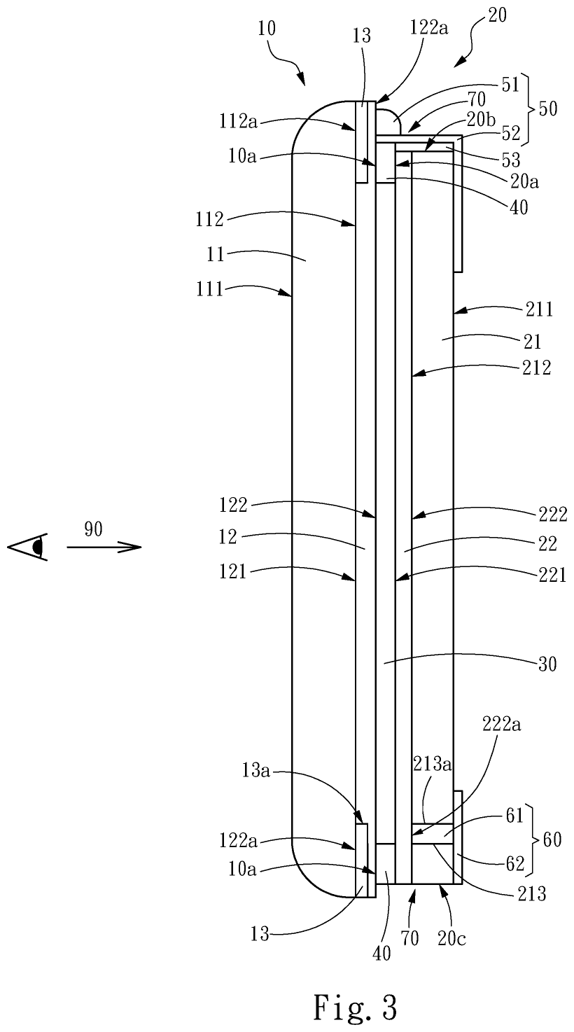

Referring to FIG. 3, in another embodiment, the first electrical connection portion 50 comprises a conductive block 51 and a conductive plate 52. The conductive block 51 can be made of a conductive adhesive, and is formed at a position on the first conductive region 122a of the light-transmitting conductive layer 12 adjacent to the second portion 20. The conductive plate 52 covers an electrical insulating member 53 disposed on the top end 20b of the second portion 20, and covers the second outer side surface 211 of the second substrate 21. The conductive block 51 contacts the conductive plate 52. Accordingly, the first electrical connection line can be connected to the conductive plate 52 and electrically connected to the light-transmitting conductive layer 12 via the conductive block 51.

To sum up, the present invention uses the through-hole provided in the rear part (that is, the second portion) as an electrical connection path for one of the electrodes, and thus it is not necessary to provide one of the electrical connection paths in the space at the bottom of the rear part (or, in other words, the path does not need to be provided in a peripheral region), thereby increasing the viewable reflective region and the area ratio of the viewable reflective region to the hiding layer.

What is claimed is:

1. An electrochromic rearview mirror assembly with a large viewable reflective region, comprising:
a first portion comprising a first substrate and a light-transmitting conductive layer, the first substrate comprising a first outer side surface and a first inner side surface, and the light-transmitting conductive layer being disposed on the first inner side surface of the first substrate;
a second portion comprising a second substrate and a transflective conductive layer, the second substrate being disposed opposite to the first substrate and comprising a second outer side surface and a second inner side surface, and the transflective conductive layer being disposed on the second inner side surface of the second substrate, wherein a viewing direction from the first portion towards the second portion is defined; and
an electrochromic medium disposed between the light-transmitting conductive layer of the first portion and the transflective conductive layer of the second portion;
wherein an area of the light-transmitting conductive layer of the first portion is greater than that of the electrochromic medium such that a first conductive region is exposed at a rear side of the light-transmitting conductive layer, and the second substrate of the second portion comprises a through-hole parallel to the viewing direction such that a second conductive region is exposed at a rear side of the transflective conductive layer.

2. The electrochromic rearview mirror assembly according to claim 1, wherein the first portion further comprises a hiding layer disposed in a peripheral region of the first inner side surface of the first substrate.

3. The electrochromic rearview mirror assembly according to claim 1, further comprising a sealing member disposed between an edge of the first portion and an edge of the second portion, wherein the light-transmitting conductive layer, the transflective conductive layer, and the sealing member define a chamber for accommodating the electrochromic medium.

4. The electrochromic rearview mirror assembly according to claim 1, further comprising:
a first electrical connection portion electrically connected to the first conductive region; and
a second electrical connection portion comprising a conductive column filled in the through-hole so as to electrically connect to the transflective conductive layer, and a conductive plate disposed on the second outer side surface of the second substrate.

5. An electrochromic rearview mirror assembly with a large viewable reflective region, comprising:
a first portion comprising a first substrate, a hiding layer, and a light-transmitting conductive layer, the first substrate comprising a first outer side surface and a first inner side surface, the hiding layer being disposed on a peripheral region of the first inner side surface of the first substrate, the light-transmitting conductive layer being disposed on a middle region of the first inner side surface of the first substrate and on the hiding layer, and the light-transmitting conductive layer located on the middle region being a viewable reflective region;
a second portion comprising a second substrate and a transflective conductive layer, the second substrate being disposed opposite to the first substrate and comprising a second outer side surface and a second inner side surface, and the transflective conductive layer being disposed on the second inner side surface of the second substrate, wherein a viewing direction from the first portion towards the second portion is defined, and the second substrate of the second portion has a through-hole parallel to the viewing direction such that a second conductive region is exposed at a rear side of the transflective conductive layer, the through-hole being close to a first lateral end of the mirror assembly;
a sealing member disposed between an edge of the first portion and an edge of the second portion, and the first portion, the second portion, and the sealing member defining a chamber, wherein an area of the light-transmitting conductive layer of the first portion is greater than that of the sealing member and the second portion such that a first conductive region is exposed at a rear side of the light-transmitting conductive layer, and a ring-shaped space is preserved outside the second portion, the first conductive region being close to a second lateral end of the mirror assembly;
an electrochromic medium disposed in the chamber;
a first electrical connection portion electrically connected to the first conductive region and accommodated in the ring-shaped space; and
a second electrical connection portion comprising a conductive column filled in the through-hole so as to electrically connect to the transflective conductive layer, and a conductive plate disposed on the second outer side surface of the second substrate;
wherein the hiding layer is at least higher than and shields the sealing member and the through-hole when viewed in the viewing direction, and the through-hole is arranged to be as close to the first lateral end of the mirror assembly as possible so that a width of the hiding layer is minimized.

6. The electrochromic rearview mirror assembly according to claim 5, wherein the second electrical connection portion is not disposed in the ring-shaped space.

7. The electrochromic rearview mirror assembly according to claim 5, wherein the ring-shaped space comprises an upper portion for accommodating the first electrical connection portion and a lower portion opposite to the upper portion, wherein the lower portion is smaller than the upper portion.

8. The electrochromic rearview mirror assembly according to claim 5, wherein the first conductive region of the light-transmitting conductive layer is close to a top end of the mirror assembly, and the second conductive region of the transflective conductive layer is close to a bottom end of the mirror assembly.
